(19) United States
(12) Patent Application Publication
(10) Pub. No.: US 2016/0371642 A1
(43) Pub. Date: Dec. 22, 2016

(54) REMOTE TEMPERATURE CONTROL OF PRODUCT STORAGE UNIT METHODS AND APPARATUSES

(71) Applicant: Wal-Mart Stores, Inc., Bentonville, AR (US)

(72) Inventor: Bruce W. Wilkinson, Rogers, AR (US)

(21) Appl. No.: 15/184,356

(22) Filed: Jun. 16, 2016

Related U.S. Application Data
(60) Provisional application No. 62/182,360, filed on Jun. 19, 2015.

(51) Int. Cl. G06Q 10/08; G05B 19/4155

(52) U.S. Cl. CPC G06Q 10/0832; G05B 19/4155; G05B 2219/37375

(57) ABSTRACT

Some embodiments provide apparatuses and methods of providing control over remote product storage units. Some systems comprises: a remote product storage unit that comprises a temperature control system configured to control a temperature within at least a temperature controlled portion of the product storage unit; a delivery control system remote from the product storage unit and comprising: a transceiver; a control circuit coupled with the transceiver; and a memory coupled to the control circuit and storing computer instructions that when executed by the control circuit cause the control circuit to: determine that a product scheduled for delivery to the product storage unit requires the temperature control system of the product storage unit to be activated; and communicate a signal to activate the temperature control system as a function of an estimated product delivery time.

### RELATED APPLICATIONS

This application claims the benefit of U.S. Provisional application No. 62/182,360, filed Jun. 19, 2015, Docket No. 8842-135312-US (816US01), which is incorporated in its entirety herein by reference.

### TECHNICAL FIELD

These teachings relate generally to product delivery and more particularly to devices, systems and methods for improving product delivery.

### BACKGROUND

In a modern retail environment, there is a need to improve the customer experience and/or convenience for the customer. Some retailers provide delivery services. Customers can order products and the delivery service will deliver the ordered products to the customer. However, there is a need to improve the delivery service to provide a better customer experience and provide greater convenience for customers.

### BRIEF DESCRIPTION OF THE DRAWINGS

The above needs are at least partially met through provision of embodiments of systems, devices, and methods designed to provide product delivery to customers, such as described in the following detailed description, particularly when studied in conjunction with the drawings, wherein:

FIG. 1 illustrates embodiments of a delivery management system configured to in part distribute instructions to control temperatures within at least portions of product storage units;

FIG. 2 illustrates a simplified block diagram of an exemplary delivery control system, in accordance with some embodiments;

FIG. 3 shows a simplified block diagram of an exemplary product storage unit, in accordance with some embodiments;

FIG. 4 illustrates a simplified flow diagram of an exemplary process of controlling temperature in one or more temperature controlled compartments of one or more product storage units, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, devices and methods are provided to improve the delivery of products to customers. In some instances, products being delivered to customers may have temperature requirements and/or it may be preferred that products be maintained at a desired storage temperature. Typically, however, unless a customer is present to receive the delivery such temperatures generally cannot be maintained. Some shopping facilities, retail services and/or delivery services provide product delivery to customers and/or provide at least some control over product deliveries to customers. Further, the product deliveries may be scheduled to accommodate a customer's schedule, preferences, rate of consumption, and the like. In some situations, a delivery of products may occur when a customer is not present at a delivery site (e.g., at a customer's home, at or near a customer's home, at a customer's office, at a commuter train station or along a route of travel, at or near an entry gate or entry to a building, etc.). As such, the security of these delivered products can be of some concern. Some embodiments, however, provide one or more product storage units or lockers that are configured to receive products delivered to a customer and be locked. A customer can later unlock the product storage unit and retrieve the delivered products. Accordingly, the product storage units can provide a measure of security to the customer and the products (groceries, prescriptions, office supplies, etc.) delivered to the delivery site.

Further, the secure delivery system can provide delivery without a consumer being present at the time of delivery. Again, customers may set up a manual/automatic shopping delivery method where items are delivered to a secure product storage container or unit at or near a designated delivery site (e.g., at or near a consumer's home). The customer interacts with the delivery system. The interaction allows the customer to select products, set delivery times, set preferences, etc. Further, the customer interaction typically occurs through a graphical user interface displayed to the customer through the customer's user interface unit (e.g., computer, laptop, smartphone, tablet, car navigation system, etc.). In some implementations, a customer accesses a software application (APP) on the customer's smartphone, tablet or the like. In accordance with selected products and a scheduled delivery, the items are delivered and locked in the product storage unit. The consumer can then later retrieve the items from the product storage unit at the customer's convenience. Accordingly, the customer does not need to be present at the time of the delivery, while still providing some security for the delivery of products.

In many instances, however, it is desirable that one or more products be maintained at one or more desired temperatures. For example, some prescription medications, perishable products, beverages, and other such products, are to be refrigerated. As another example, some customers may participate in a meal planning service where one or more products used in preparing a pre-planned meal (typically planned by a shopping facility or other service) are delivered to a customer, and one or more of the products should be maintained at a cooled or heated temperature. As yet another example, some customers may participate in a meal service where one or more products are delivered ready to eat and at least some of the products should be maintained at a heated temperature. Accordingly, some product storage units may be configured to include one or more temperature control systems configured to control a temperature within at least one or more temperature controlled portions or compartments of the product storage unit. Some embodiments are configured to remotely control the temperature control system to activate in accordance with a scheduled delivery of a product that should be maintained at a temperature that is different than an anticipated, typical or actual temperature within the storage unit when the temperature control system is not controlling the temperature.

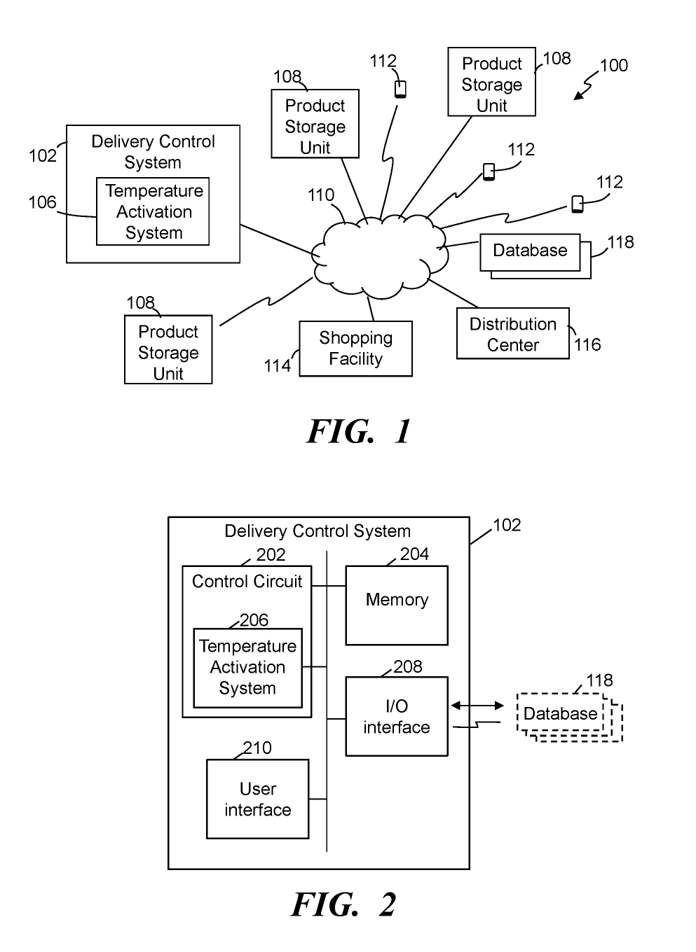

Referring now to the drawings, FIG. 1 illustrates embodiments of a delivery management system 100 configured to in part distribute instructions to control temperatures within at least portions of product storage units 108. The delivery management system 100 includes a delivery control system 102 that includes one or more temperature activation systems 106, and multiple product storage units 108. In some embodiments, the delivery management system further includes or is in communication with one or more shopping facilities 114, one or more product distribution centers 116, and multiple customer user interface units 112. The delivery management system may communicate with one or more of the product storage units 108, the user interface units 112, the shopping facility 114, and/or the product distribution center 116 through one or more communication and/or data networks 110, such as the Internet, one or more wide area networks (WAN), one or more local area networks (LAN), one or more cellular communication networks, other such networks, or combinations of two or more of such networks.

Further, some embodiment include one or more databases 118 accessible by the delivery control system 102, and in some instances accessible by one or more of the user interface units 112, shopping facility 114, and/or distribution center 116. Such databases may be integrated into the delivery control system or separate from it. Further, such databases may be at the location of the delivery control system, the shopping facility 114, and/or distribution center 116, or remote from one or more of the delivery control system, the shopping facility, and distribution center. Regardless of location, the databases comprise memory to store and organize certain data for use by the delivery control system. In some embodiments, the at least one database 118 may store data pertaining to one or more of: customer profile information; customer orders; scheduling for deliveries; product information; desired product temperatures; customer shopping data and patterns; inventory data; product pricing data; product storage unit locations; delivery site locations; and/or other relevant information for use in supporting the delivery of products, customers, the shopping facilities and distribution centers, and implementing and controlling temperature within a temperature controlled compartment of product storage units.

The multiple product storage units 108 are geographically distributed and provide delivery sites correspond to different customers. Further, in some instances, the product storage units include one or more temperature control systems, one or more temperature controlled compartments, one or more processors, at least one memory, and one or more transceivers configured to communicate with at least the delivery control system. Although FIG. 1 shows three product storage units 108, three customer user interface units 112, one shopping facility 114 and one distribution center 116, it will be appreciated by those skilled in the art that in some embodiments delivery management system 100 can be configured to support thousands or even hundreds of thousands of customers or more, and communicate with thousands or even hundreds of thousands of product storage units in causing adjustments to temperatures in a temperature controlled compartment of the product storage units. Similarly, although the delivery control system 102 is depicted as a single device, in some implementations the delivery control system is implemented through multiple devices and/or processors distributed over one or more communication and/or data networks 110. It is understood that more or fewer of such components may be included in different embodiments of the system 100.

The delivery control system 102 issues instructions to remote product storage units 108 to sets and/or adjust temperatures within at least one or more temperature controlled compartments of the product storage units (e.g., a refrigerated portion, an insulated portion, a heating portion, etc.). In some implementations, the delivery control system may further access and/or manage delivery schedules of one or more products to numerous delivery sites for multiple different customers. Typically, the temperature activation system 106, based on the products scheduled to be delivered with one or more products having desired temperatures, determines an activation time to achieve a desired temperature within a product storage unit scheduled to receive the product delivery. The temperature activation system further identifies an expected delivery time of a product that has a temperature preference, and issues one or more instructions to the product storage unit to cause an activation of a temperature control system within the product storage unit to achieve a desired temperature at the expected delivery time.

FIG. 2 illustrates a simplified block diagram of an exemplary delivery control system 102, in accordance with some embodiments. As described above, the delivery control system is configured to identify product deliveries having one or more products with desired temperatures, and activate a temperature control system of a product storage unit 108. In this example, the delivery control system includes at least one control circuit 202, at least one memory 204, at least one temperature activation system 206, and one or more input/output (I/O) interfaces 208. In some implementations, the delivery control system includes one or more user interfaces 210 configured to allow users to interact with the delivery control system. In some embodiments, the delivery control system and/or the control circuit 202 can be implemented through one or more servers and/or computers operated remote from delivery sites, user interface units 112, product storage units 108, and customers' residences. Further, the plurality of computers and/or servers may be distributed over one or more communication networks (e.g., the communication network 110), and may be geographically distributed while still being communication coupled to cooperatively operate to perform the functions of the delivery control system. Similarly, the one or more servers may be implemented remote from shopping facilities 114 and/or distribution centers 116. In other implementations, however, some or all of the delivery control system may be implemented at one or more shopping facilities and/or distribution centers.

Further, the delivery control system may be utilized with a single shopping facility (e.g., such as a store location, shopping mall, retail campus, or the like) or distribution center, while in other implementations, the delivery control system may extend across multiple shopping facility locations and/or distribution centers. The control circuit 202 typically comprises one or more processors and/or microprocessors. The control circuit couples with and/or includes the memory 204. Generally, the memory 204 stores the operational code or one or more sets of instructions that are executed by the control circuit 202 and/or processor to implement the functionality of the delivery control system. In some embodiments, the memory 204 may also store some or all of particular data that may be needed to identify locations of product storage units, functionalities and/or features of product storage units, desired temperatures of products, delivery schedules, delivery routes, timing of deliveries, and the like. Such data may be pre-stored in the memory or be received, for example, from inventory systems, a product ordering system (e.g., operated through a website, an APP on a user interface unit, etc.), point of sale systems, shopping facility systems, product storage units, user interface units, other sources, or combinations of such sources.

It is understood that the control circuit may be implemented as one or more processor devices as are well known in the art. Further, the control circuit may be implemented through multiple processors dispersed over the communication network. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the delivery control system; however, the memory 204 can be internal, external or a combination of internal and external memory. Additionally, the delivery control system may include a power supply (not shown) and/or it may receive power from an external source. In some instances, the control circuit 202 and the memory 204 may be integrated together, such as in a microcontroller, application specification integrated circuit, field programmable gate array or other such device, or may be separate devices coupled together. In some applications, the control circuit 202 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 208 allow wired and/or wireless communication coupling of the delivery control system to external components, such as the product storage units 108, the databases 118, the user interface units 112, shopping facilities systems, distribution center systems, point of sale systems, and other such components. Accordingly, the I/O interface 208 may include any known wired and/or wireless interfacing device, circuit and/or connecting device, such as but not limited to transceivers, receivers, transmitters, and the like. For example, in some implementations, the I/O interface 208 provides wireless communication in accordance with one or more wireless protocols (e.g., cellular, Wi-Fi, Bluetooth, radio frequency (RF), other such wireless communication, or combinations of such communications). In some implementations, the I/O interface includes one or more transceivers configured to couple with and transmit and/or receive communications from over the distributed communication network 110.

One or more user interfaces 210 can be included in and/or couple with the delivery control system, and can include substantially any known input device, such one or more buttons, knobs, selectors, switches, keys, touch input surfaces and/or displays, etc. Additionally, the user interface may include one or more output display devices, such as lights, visual indicators, display screens, etc. to convey information to a user, such as but not limited to product storage unit identifiers, product storage unit location information, customer location information, maps, scheduled product deliveries, product information, product identifiers, customer profile information, product consumption information, graphical user interfaces, purchase information, status information, history information, notifications, errors, conditions and/or other such information. While FIG. 2 illustrates the various components being coupled together via a bus, it is understood that the various components may actually be coupled to the control circuit 202 and/or one or more other components directly.

The delivery control system further includes the temperature activation system 206 that determines when temperature control system of a product storage unit is to be activated and what temperature is to be maintained within the temperature controlled compartment. In some embodiments, the temperature activation system is part of and implemented through the control circuit, while in other embodiments, some or all of the temperature activation system is external to the control circuit or similarly may be external to the delivery control system. The delivery control system identifies when a product, scheduled to be delivered to a product storage unit, has a desired storage temperature. The desired temperature may be defined by a product manufacturer and/or supplier (e.g., a pharmaceutical company may instruct that a prescription be maintained at a temperature between 35° F. and 50° F.; supplier of milk recommends milk be maintained between 34° F. and 42° F.; supplier of ice cream recommends ice cream be maintained at below 30° F.; etc.), may be defined by a meal planning service, may be based on an expected time of consumption by the customer, may be defined based on a product having been cooked, and other such sources, factors, conditions, or combinations thereof.

In some embodiments, the control circuit 202 determines whether to authorize the delivery of one or more products to a product storage unit. The control circuit may identify whether a product storage unit has a temperature control system and/or whether the temperature control system can provide a desired temperature. For example, a product storage unit may have a temperature control system that can provide refrigeration, but may not have a heating capability, or vice versa. While in other embodiments, a product storage unit may include both a heating and a cooling capability. Accordingly, the control circuit may determine whether to authorize a delivery based on whether a product storage unit can achieve the desired temperature. Similarly, in some instances, the control circuit has knowledge of the dimensions of the temperature controlled compartment and acquires dimension information (e.g., from the database) for the one or more products that are to be placed in a temperature controlled compartment. Based on the dimensions, the control circuit can identify whether the one or more products are going to fit within the temperature controlled compartment, and can authorize or prevent the delivery over one or more of the products based on the determination of whether the one or more products intending to be delivered are going to fit. In some embodiments, product storage profiles may be maintained by the control circuit 202 and/or accessed through the memory 204 or the databases. Additionally or alternatively, customer profiles may be maintained and/or accessed that identify one or more product storage units associated with the customer and for which products purchased by the customer may be delivered. Product storage unit profiles and/or customer profiles may be updated over time, for example, based on movement of a product storage unit, modification of a product storage movement (e.g., a heating system and/or cooling system and corresponding compartment may be added to already distributed product storage unit), a customer moving living or working locations, customer changing or upgrading their membership status with the delivery server, customer's modification of desired delivery scheduling, and the like.

Further, in some implementations, the control circuit 202 is further configured to identify when multiple products are to be temperature controlled, and to further identify whether each of the multiple products can be placed in the same temperature controlled compartment. For example, the control circuit can be configured to determine whether the multiple products have similar desired storage temperatures; whether it is acceptable that one product be placed within the temperature controlled compartment even though the temperature may be different than a desired storage temperature (e.g., acceptable to be placed in compartment that is at a temperature below a desired storage temperature); or the like. The control circuit can further be configured to determine whether there are multiple temperature controlled compartments that can be maintained at different temperatures, and identify which products to be delivered are to be placed into which temperature controlled compartments. Instructions may be provided to a delivery person regarding which products are to be placed in which compartments. In some instances, the product storage unit may be provided with the information identifying which products are to be placed in which temperature control compartments, which can then provide this information to the delivery person at the time of delivery. Further, in some instances, the product storage unit may have an RFID detector, bar code reader or other product identifying system that can detect a product being placed within the product storage unit and can notify the delivery person, in response to detecting the product, a compartment into which the product is to be placed.

The control circuit and/or temperature activation system further typically has information that defines and/or is used to calculate an adjustment duration of time adjustment duration of time to cause the temperature control system to adjust the temperature within a temperature controlled compartment of the product storage unit to a desired temperature, and typically the adjustment durations of time it takes to adjust the temperature within the compartment to each of multiple different temperatures. This timing may take into consideration a current or predicted temperature, at a time the temperature control system is to be activated, within the temperature controlled compartment. Using this information, the temperature activation system can predict and/or be provided with an estimated time the product is to be delivered to a product storage unit. Based on the time to achieve a threshold temperature and the estimated time of delivery, the temperature activation system can identify threshold time when the temperature control system of the product storage unit could be activated so that the temperature within the temperature controlled compartment of the product storage unit can establish the threshold temperature within the temperature controlled compartment. The estimated time of delivery can be calculated based on various factors, such as number of deliveries, number of delivery personnel, number of delivery vehicles, predicted and/or average travel times (e.g., based on expected traffic, historical times, etc.), and the like. The estimated time of delivery may be adjusted over time, for example, based on a delivery vehicles location over time, delivery route, number of deliveries scheduled prior to a delivery being considered, etc.

Some embodiments further take into consideration current and/or forecasted environmental conditions exterior to and/or proximate the product storage unit. The exterior temperature and forecasted temperature can have an effect on the duration of time needed by the temperature control system to achieve a specified temperature. For example, there may be a weather front that might drop the exterior temperature so fast that a determined duration of time to reach a desired temperature based on a current temperature, when heating the temperature controlled compartment, would result in the temperature controlled compartment not reaching the desired temperature by the delivery time. Accordingly, some embodiments continue to track environmental conditions and/or forecasted conditions in determining and/or adjusting start times and/or rates of change in temperature at which the temperature control systems operate.

The temperature activation system can cause a temperature trigger or activation instruction to be communicated to the temperature control system (e.g., via cellular communication, Wi-Fi, Internet (e.g., the product storage unit may have a given IP address), or other such communications or combinations of two or more of such communications). The temperature activation instruction can be sent at the time the temperature control system is to be activated such that the temperature control system is activated in response to receiving the instruction. In other instances, the temperature activation instruction is transmitted prior to the time when the temperature control system is to be activated and specifies a time of activation. The temperature control system or other control circuit tracks timing, and the temperature control system is activated at the time specified in the previously received temperature activation instruction.

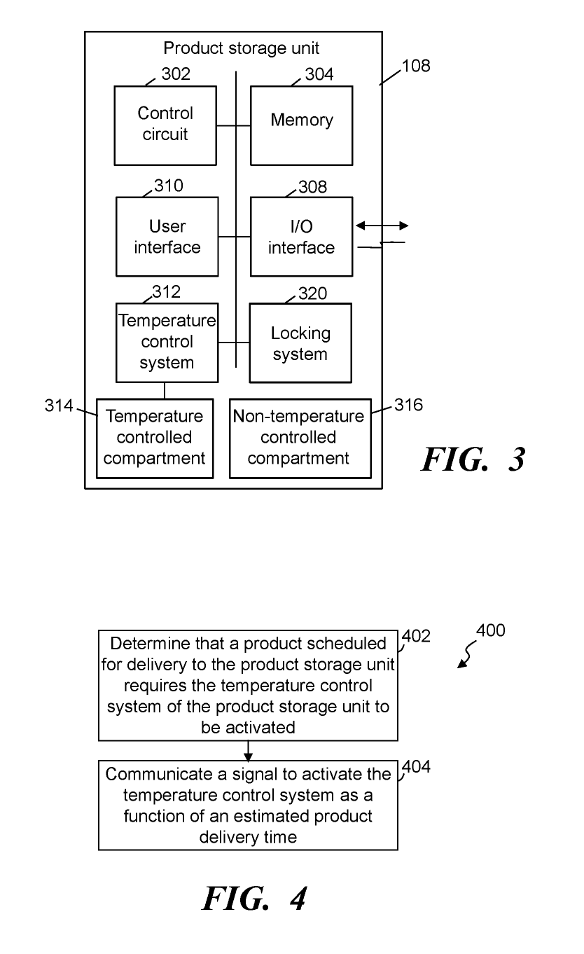

FIG. 3 shows a simplified block diagram of an exemplary product storage unit 108, in accordance with some embodiments. In this example, the product storage unit includes at least one control circuit 302, at least one memory 304, one or more input/output (I/O) interfaces 308, at least one temperature control system 312, at least one temperature controlled compartment 314, and in some instances a non-temperature controlled compartment 316. In some implementations, the product storage unit includes one or more user interfaces 210 configured to allow users to interact with the delivery control system. Additionally, some embodiments include one or more locking systems 320.

The control circuit 302 typically comprises one or more processors and/or microprocessors. The control circuit couples with and/or includes the memory 304. Generally, the memory 304 stores the operational code or one or more sets of instructions that are executed by the control circuit 302 and/or processor to implement the functionality of the delivery control system. In some embodiments, the memory 304 may also store some or all of particular data that may be needed to implement temperature control, receive temperature activation instructions, lock and unlock when appropriate, maintain product information, maintain a product storage unit identifier, desired temperatures of products, delivery schedules, timing of deliveries, timing when deliveries are retrieved from the product storage unit, and the like. Such data may be pre-stored in the memory or be received, for example, from the delivery control system 102, inventory systems, shopping facility systems, user interface units, other sources, or combinations of such sources.

It is understood that the control circuit 302 may be implemented as one or more processor devices as are well known in the art. Further, the control circuit may be implemented through multiple processors dispersed over the communication network. Similarly, the memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the product storage unit 108; however, the memory 304 can be internal, external or a combination of internal and external memory. Additionally, the delivery control system may include a power supply (not shown) and/or it may receive power from an external source. The power supply may include a rechargeable power storage unit (e.g., battery, capacitor, etc.), that couples with a power source, such as solar panel, wind turbine, other such sources or combination of such sources. In some instances, the control circuit 202 and the memory 204 may be integrated together, such as in a microcontroller, application specification integrated circuit, field programmable gate array or other such device, or may be separate devices coupled together. In some applications, the control circuit 302 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 308 allow wired and/or wireless communication coupling of the product storage unit to external components, such as the delivery control system 102, temperature activation system 106, the user interface units 112, shopping facilities systems, distribution center systems, and other such components. Accordingly, the I/O interface 308 may include any known wired and/or wireless interfacing device, circuit and/or connecting device, such as but not limited to transceivers, receivers, transmitters, and the like. For example, in some implementations, the I/O interface provides wireless communication in accordance with one or more wireless protocols (e.g., cellular, Wi-Fi, Bluetooth, radio frequency (RF), other such wireless communication, or combinations of such communications). In some implementations, the I/O interface includes one or more transceivers configured to couple with and transmit and/or receive communications from over the distributed communication network 110.

The product storage unit, in at least some embodiments, further includes one or more temperature controlled compartments 314 that are configured to receive one or more products. The temperature control system cooperates with the temperature controlled compartment and is configured to maintain an instructed temperature within the temperature controlled compartment. Further, some embodiments may include one or more non-temperature controlled compartments also configured to receive one or more products that can be stored at uncontrolled temperatures. The temperature controlled compartment may further provide temperature feedback to the temperature control system. For example, one or more thermometers or other such temperature measuring device may be cooperated with and/or within the temperature controlled compartment 314 to measure temperature and provide measured temperature information back to the temperature control system. Similarly, in some embodiments, the product storage unit may include one or more external temperature measuring devices and/or other such environment measuring devices that can be used by the temperature control system and/or communicated to the product delivery system for use in determining a threshold temperature adjustment time and/or determine when to activate the temperature control system to achieve a threshold temperature within the temperature controlled compartment by an intended time (e.g., within a threshold time of an estimated product delivery time).

Still further, some embodiments include one or more locking systems 320 that allow the product storage unit and/or one or more compartments within the product storage unit to be locked. The locking system includes one or more locks. Further in some embodiments, the locking system is configured to receive electronic inputs, such as codes or sequences of pressed buttons from a user interface 310, communicated codes from a user interface unit, lock and unlock instructions from the delivery control system 102 and the like. For example, a customer may wirelessly transmit an unlock code from her/his user interface unit 112 (e.g., via Bluetooth, RFID, Wi-Fi, etc.) to the product storage unit that is routed to the locking system that evaluates the unlock code in confirming the customer prior to unlocking one or more compartments within the product storage unit. The locking system may utilize different locking codes for different compartments within the product storage unit. This can allow a single product storage unit to be used by different customer, and/or to ensure a specific customer (e.g., an adult) has access to a compartment (e.g., to retrieve alcoholic beverages, prescriptions, etc.).

One or more user interfaces 310 can be included in and/or couple with the delivery control system, and can include substantially any known input device, such one or more buttons, knobs, selectors, switches, keys, touch input surfaces and/or displays, etc. Additionally, the user interface may include one or more output display devices, such as lights, visual indicators, LEDs, display screens, etc. to convey information to a user, such as but not limited to, time of delivery, lock status, temperature, delivery identifier, product storage unit identifiers, status information, notifications, errors, conditions and/or other such information. While FIG. 3 illustrates the various components being coupled together via a bus, it is understood that the various components may actually be coupled to the control circuit 202 and/or one or more other components directly.

Further, often the product storage units may be powered by a local power source and/or a local rechargeable power source (e.g., charged through solar panels, through wind turbine, or the like). As such, some embodiments attempt to limit the power usage at the product storage unit. The control of the activation of the temperature control system can further take into consideration the power level of a local power source of the product storage unit. Similarly, in determining the temperature activation instruction some embodiments attempt to define a start time that reduces the duration the temperature control system is active. Additionally, some embodiments, in part to limit power consumption, set a start time that is predicted to achieve a first temperature in the temperature controlled compartment at the estimated time of delivery, where the first temperature is actually different than the desired storage temperature of the one or more products. The temperature control system, however, continues to adjust the temperature to achieve the desired storage temperature within a threshold time.

FIG. 4 illustrates a simplified flow diagram of an exemplary process 400 of controlling temperature in one or more temperature controlled compartments 314 of one or more product storage units 108, in accordance with some embodiments. In step 402, it is determined that a product that is scheduled for delivery to a product storage unit requires the temperature control system of the product storage unit to be activated. In determine that a product needs the temperature control system activated, some embodiments further identify that a product delivery of one or more products is scheduled to occur at a product storage unit corresponding to a customer. For example, a meal planning engine may have specified planned deliveries of ingredients to one or more customers. The deliveries may be to a customer's residence, a product storage unit, a business location, or other such delivery sites. In other instances, a customer may have scheduled a delivery, scheduled deliveries based on a predefined schedule (e.g., weekly), a delivery may be scheduled based on a predicted consumption rate of a product (e.g., milk, eggs, or other such products), or the like. Accordingly, a scheduling system may have records of pending deliveries, and in response to a delivery being within a threshold time notifies the delivery control system. Further, the product needing the temperature control may be identified that is to be maintained at a predefined temperature. In some embodiments, product data is maintained for products that should be maintained at a desired temperature, below a predefined temperature, above a predefined temperature, and/or typically within a temperature range (e.g., between 10° F. and 40° F.; between 95° F. and 165° F.; etc.). The product data may identify, for example, one or more of a minimum temperature, maximum temperature, preferred temperature, temperature range, or other such temperature. The control circuit may access the product data as a function of the product being scheduled to be delivered, and use the product data to identify that a product is to be maintained at a specified temperature, below a specified temperature, above a specified temperature and/or within a temperature range.

In step 404, a signal to activate the temperature control system is communicated as a function of an estimated product delivery time. The estimated product delivery time may be identified regarding when one or more products are predicted to be delivered to the product storage unit. This can be based on a delivery schedule, route information, traffic information, feedback from a delivery truck and/or a delivery person's user interface unit, or the like. In some instances, a route controller on a delivery vehicle and/or operated remote from the delivery vehicle may determine an estimated delivery time and provide that information to the delivery control system. For example, a current location of a delivery vehicle can be received and an estimated time of travel can be determined to the delivery site (e.g., based on past travel, current travel rates, predicted traffic congestion, other deliveries scheduled prior to the delivery being considered, whether a driver is scheduled to take a lunch or break, etc.), and a predicted delivery time may be determined as a function of a current time and the estimated time of travel.

Some embodiments further identify or determine a threshold temperature adjustment time of the product storage unit as a function of the estimated product delivery time. Further, the transceiver can be activated to communicate to the product storage unit the activation signal and/or temperature activation instruction configured to cause the temperature control system 312 of the product storage unit to adjust the temperature in the temperature controlled portion to a first temperature within the first threshold temperature adjustment time. This activation will cause an adjustment to temperature within the temperature controlled compartment of the product storage unit such that when the delivery person arrives the temperature controlled compartment is at a desired temperature and she/he places the one or more roe items into the temperature controlled compartment. In some embodiments, the product storage unit 108 and/or the temperature controlled compartment 314 may include an RFID temperature tag recorder, bar code reader or the like that obtains temperature information for one or more products and can confirm the temperature within the temperature controlled compartment is correct for the received one or more items. This may include communicating with the delivery control system 102 to confirm an accurate temperature. In some instances, the product storage unit may notify the delivery person (e.g., through a display, an audio notification, illumination of one or more LEDs, etc.) that the correct temperature is obtained before she/he leaves the delivery in the product storage unit. In other instances, the delivery control system may cause a communication to be sent to the delivery person (e.g., via cellular to the delivery person's user interface unit). In some applications, the use of RFID tag reader, bar code reader or other sensor, may further allow notification to the delivery person that the items that are to be placed in the temperature controlled compartment are accurately placed.

Some embodiments further identify an amount or duration of time to adjust temperature within the storage unit. The control circuit 202, in identifying the threshold temperature adjustment time of the first product storage unit, further identifies an adjustment duration of time to cause the temperature control system of the product storage unit to adjust the temperature within the temperature controlled portion to a desired temperature, and identifies the first threshold temperature adjustment time as a function of the estimated delivery time and the adjustment duration. Further, some embodiments receive external temperature data and determine the temperature adjustment time as a function of temperature external to the product storage unit. The control circuit can be configured to receive temperature data of a temperature outside the product storage unit and determine the adjustment duration as a function of the temperature data. Still further, some embodiments determine the temperature adjustment time as a function of forecasted weather. The control circuit in identifying the adjustment duration further receives weather forecast data for forecasted weather at the location of the product storage unit and determines the adjustment duration as a function of the weather forecast data. Additionally, the adjustment duration is generally also dependent on a temperature within the temperature controlled portion at the time the temperature control system starts to control the temperature. As such, the control circuit in determining the temperature adjustment duration further receives a current internal temperature within the temperature controlled portion and determines the adjustment duration as a function of the current internal temperature.

Some embodiments attempt to minimize energy consumption. As such, the control circuit, in some implementations, is configured to identify an activation time when the temperature control system is to be activated consistent with the estimated delivery time and the adjustment duration while minimizing energy consumption by the temperature control system. In some instances, the activation time is specified to achieve a desired temperature at approximately the estimated time of delivery. The desired temperature may be different than a final temperature to be achieved in the temperature controlled compartment, but within a threshold temperature of the final temperature.

The delivery control system 102 and/or the product storage unit 108 can further be configured to turning off the temperature control system. This may occur in response to a detection or confirmation that the customer has retrieved the one or more delivered products, based on a timing (e.g., the temperature control system has been active for a threshold period of time), or the like. In some embodiments, the control circuit is configured to receive a confirmation from the product storage unit that the one or more products were removed from the temperature controlled portion of the product storage unit, and causes the transceiver to communicate a power down or termination instruction to the product storage unit to cause the temperature control system to shut down or otherwise stop maintaining a temperature. For example, the product storage unit may detect through RFID tag reading, optical scans of bar codes, weight sensors, one or more other such detectors, or a combination of two or more of such sensors, that the product or products have been removed. In some instances, a customer may communication a confirmation that products have been received (e.g., through user interface unit), a customer may communicate a request to unlock a product storage unit, or other such confirmation. Based on the confirmation the delivery control system and/or the product storage unit may power down one or more temperature control systems or limit the operation of the temperature control system so that it no longer maintains the temperature of one or more temperature controlled compartments, or adjusts the controlled temperature to a more moderate temperature such that less energy is used to maintain the moderate temperature.

Some embodiments further obtain a confirmation that the correct predefined customer is accessing the product storage unit prior to opening or unlocking the product storage unit. For example, the control circuit of the delivery control system can be configured to receive a confirmation that the customer is present to receive at least the product within the temperature controlled compartment, and trigger an unlocking of at least the temperature controlled compartment of the product storage unit allowing the customer access to the product in response to receiving the confirmation that the customer is present.

In some embodiments, the threshold temperature adjustment time designates a period of time during which the temperature within the temperature controlled compartment is to equal or be within a threshold temperature of the intended temperature. This threshold temperature adjustment time is typically dependent on the intended temperature, which is defined for one or more product to be placed within the temperature controlled compartment. Further, period of time may be dependent on how critical to a product it is that a temperature of the product be maintained. As such, the threshold temperature adjustment time may in some instances define a period of time prior to the estimated delivery time, while in other instances may include the estimated product delivery time. Further, the threshold temperature adjustment time may also be dependent on a temperature within the temperature controlled compartment at the time of starting to control the temperature within the temperature controlled compartment, the estimated time of delivery, the temperature external to the product storage unit, forecasted environmental conditions and/or temperature, and the like.

In some embodiments, the temperature within the temperature controlled compartment of the product storage unit may be modified over time. For example, some embodiments may modify a temperature based on a remaining available power level of a power source. Some embodiment may change the temperature within the temperature controlled compartment based on an estimated time of when the products are to be retrieved from the product storage unit. For example, an initial temperature may be set to keep a product, which was previously cooked, warm. The temperature can subsequently increase at a determined time, for example, so that one or more products are at a preferred temperature for consumption at an estimated time the products will be retrieved from the product storage unit by the customer. The initial lower temperature can keep the one or more products warm without drying out the products, while the second increased temperature puts the product at a desired temperature to be eaten. This may be advantageous, for example, with a meal planning service.

Again, the delivery control system causes a temperature activation instruction to be communicated to one or more product storage units in response to determining that a product scheduled to be delivered is to be maintained at a desired temperature. In some implementations, the control circuit 302 of the product storage unit activates the temperature control system and/or causes an activation signal to be communicated to the temperature control system in response to receiving the temperature activation instruction. The temperature control system, in some instances, may notify the control circuit 302 when the temperature control system is actually activated (e.g., in accordance with an activation time) confirming that the temperature control system is active and temperature within the temperature controlled compartment is being controlled. This confirmation or other such notification may, in some applications, be communicated to the delivery control system. Additionally or alternatively, in some embodiments, a confirmation that a desired temperature within the temperature controlled compartment is achieved and ready to receive the one or more products may be communicated to the delivery control system. As described above, in some embodiments, the delivery control system may be further configured to communicate power down or deactivate instruction to the product storage unit to cause the temperature control system to power down or transition to a sleep state (which may maintain one or more temperature controlled compartments at a temperature that requires less power to maintain). Alternatively or additionally, in some instances, the control circuit 302 may issue a power down or sleep instruction in response to detecting or receiving a confirmation that the customer has retrieved the one or more products. As such, some embodiments activate the temperature control system and operate the temperature control system just prior to or when a delivery is in progress, while maintaining the temperature control system in powered down or deactivated state when temperature within the product storage unit does not need to be controlled.

In some embodiments, apparatuses, systems and methods are provided herein useful in providing control over remote product storage units. In some embodiments a system comprises: a remote product storage unit that comprises a temperature control system configured to control a temperature within at least a temperature controlled portion of the product storage unit; a delivery control system remote from the product storage unit and comprising: a transceiver; a control circuit coupled with the transceiver; and a memory coupled to the control circuit and storing computer instructions that when executed by the control circuit cause the control circuit to: determine that a product scheduled for delivery to the product storage unit requires the temperature control system of the product storage unit to be activated; and communicate a signal to activate the temperature control system as a function of an estimated product delivery time.

In some embodiments, a method comprises by a control circuit of a product delivery control system: determining that a product scheduled for delivery to a remote product storage unit requires a temperature control system of the product storage unit to be activated; and communicating a signal to activate the temperature control system as a function of an estimated product delivery time.

In some embodiments, apparatuses and methods are provided herein useful in providing control over remote product storage units. In some embodiments, an apparatus comprises: multiple remote product storage units geographically distributed at multiple different product delivery sites, wherein each of the multiple product storage units comprises a temperature control system configured to control a temperature within at least a temperature controlled portion of the product storage unit; a delivery control system remote from the multiple product storage units and comprising: a transceiver configured to communicate with the multiple remote product storage units; a control circuit coupled with the transceiver; and a memory coupled to the control circuit and storing computer instructions that when executed by the control circuit cause the control circuit to: identify that a product delivery of one or more products is scheduled to occur at a first product storage unit corresponding to a first customer; identify that a first product of the one or more products is to be maintained at a predefined temperature; identify an estimated product delivery time when the one or more products are predicted to be delivered to the first product storage unit; identify a first threshold temperature adjustment time of the first product storage unit as a function of the estimated product delivery time; and cause the transceiver to communicate, to the first product storage unit, a temperature activation instruction configured to cause the temperature control system of the first product storage unit to adjust the temperature in the temperature controlled portion to a first temperature within the first threshold temperature adjustment time.

In some embodiments, a method comprises by a control circuit of a product delivery control system: identifying, through the control circuit of the product delivery control system configured to coordinate the product deliveries to multiple remote product storage units geographically distributed at multiple product delivery sites, a product delivery of one or more products scheduled to occur at a first product storage unit corresponding to a first customer; identifying that a first product of the one or more products is to be maintained at a predefined temperature; identifying an estimated product delivery time when the one or more products are predicted to be delivered to the first product storage unit; identifying a first threshold temperature adjustment time of the first product storage unit as a function of the estimated product delivery time; and causing the transceiver to communicate, to the first product storage unit, a temperature activation instruction configured to cause a temperature control system of the first product storage unit to adjust the temperature in the temperature controlled portion to a first temperature within the first threshold temperature adjustment time.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system providing control over remote product storage units, comprising:
a remote product storage unit that comprises a temperature control system configured to control a temperature within at least a temperature controlled portion of the product storage unit;
a delivery control system remote from the product storage unit and comprising:
a transceiver;
a control circuit coupled with the transceiver; and
a memory coupled to the control circuit and storing computer instructions that when executed by the control circuit cause the control circuit to:
determine that a product scheduled for delivery to the product storage unit requires the temperature control system of the product storage unit to be activated; and
communicate a signal to activate the temperature control system as a function of an estimated product delivery time.

2. The system of claim 1, wherein the control circuit further identifies an adjustment duration of time to cause the temperature control system of the first product storage unit to adjust the temperature within the temperature controlled portion to a first temperature, wherein the communicating the signal comprises communicating the signal to cause the activation of the temperature control system based on the estimated product delivery time and the adjustment duration.

3. The system of claim 2, wherein the control circuit in identifying the adjustment duration further receives external temperature data of a temperature outside the product storage unit and determines the adjustment duration as a function of the external temperature data.

4. The system of claim 3, wherein the control circuit in identifying the adjustment duration further receives weather forecast data for forecasted weather proximate a location of the product storage unit and determines the adjustment duration as a function of the weather forecast data.

5. The system of claim 2, wherein the control circuit is further configured to identify an activation time when the temperature control system is to be activated consistent with the estimated delivery time and the adjustment duration while minimizing energy consumption by the temperature control system.

6. The system of claim 1, wherein the control circuit is further configured to receive a confirmation from the product storage unit that the product was removed from the temperature controlled portion of the product storage unit, and in response communicate a termination instruction to the product storage unit to cause the temperature control system to shut down.

7. The system of claim 1, wherein the control circuit is further configured to receive a confirmation that a predefined customer is present to receive at least the product, and trigger an unlocking of at least a portion of the product storage unit allowing the customer access to the product in response to receiving the confirmation that the customer is present.

8. The system of claim 1, wherein the control circuit is further configured to:
identify that the product is to be maintained at a predefined temperature;
identify an estimated product delivery time when the product is predicted to be delivered to the product storage unit; and
identify a threshold temperature adjustment time of the product storage unit as a function of the estimated product delivery time;
wherein the communicating the signal to activate the temperature control system comprises cause the transceiver to communicate, to the product storage unit, a temperature activation instruction configured to cause the temperature control system of the product storage unit to adjust the temperature in the temperature controlled portion to a first temperature within the threshold temperature adjustment time.

9. A method of providing control over remote product storage units, comprising:
by a control circuit of a product delivery control system:
determining that a product scheduled for delivery to a remote product storage unit requires a temperature control system of the product storage unit to be activated; and
communicating a signal to activate the temperature control system as a function of an estimated product delivery time.

10. The method of claim 9, further comprising:
identifying an adjustment duration of time to cause the temperature control system of the product storage unit to adjust the temperature within the temperature controlled portion to a first temperature, wherein the communicating the signal comprises communicating the signal to cause the activation of the temperature control system based on the estimated product delivery time and the adjustment duration.

11. The method of claim 10, wherein the identifying the adjustment duration further comprises:
receiving external temperature data of a temperature outside the product storage unit; and
determining the adjustment duration as a function of the external temperature.

12. The method of claim 11, wherein the identifying the adjustment duration further comprises:
receiving weather forecast data for forecasted weather proximate a location of the product storage unit; and
determining the adjustment duration as a function of the weather forecast data.

13. The method of claim 10, further comprising:
identifying an activation time when the temperature control system is to be activated consistent with the estimated delivery time and the adjustment duration while minimizing energy consumption by the temperature control system.

14. The method of claim 9, further comprising:
receiving a confirmation from the product storage unit that the product was removed from the temperature controlled portion of the product storage unit; and
communicating a termination instruction to the product storage unit to cause the temperature control system to shut down.

15. The method of claim 9, further comprising:
receiving a confirmation that the a predefined customer is present to receive at least the product; and
triggering an unlocking of at least a portion of the product storage unit allowing the customer access to the product in response to receiving the confirmation that the customer is present.

16. The method of claim 9, further comprising:
identifying that the product is to be maintained at a predefined temperature;
identify an estimated product delivery time when the product is predicted to be delivered to the product storage unit; and
identify a threshold temperature adjustment time of the product storage unit as a function of the estimated product delivery time;
wherein the communicating the signal to activate the temperature control system comprises communicating, to the product storage unit, a temperature activation instruction configured to cause the temperature control system of the product storage unit to adjust the temperature in the temperature controlled portion to a first temperature within the threshold temperature adjustment time.
